(19) United States
(12) Patent Application Publication
(10) Pub. No.: US 2011/0030118 A1
(43) Pub. Date: Feb. 10, 2011

(54) WRAP-AROUND HARNESS ASSEMBLY

(75) Inventor: Vincent J. Pratchett, Toronto (CA)

Correspondence Address: THOMPSON HINE L.L.P.;Intellectual Property Group, P.O. BOX 8801, DAYTON, OH, 45401-8801, US

(73) Assignee: Lion Apparel, Inc., Dayton, OH (US)

(21) Appl. No.: 12/537,469

(22) Filed: Aug. 7, 2009

(51) Int. Cl. A62B 17/00; A41D 13/00; A41D 3/02; A41D 27/00

(52) U.S. Cl. 2/81; 2/82; 2/85; 2/93; 2/243.1

(57) ABSTRACT

A protective garment including an outer shell and a harness assembly configured to be generally positioned between the outer shell and a wearer of the garment when the garment is worn. The harness assembly includes a wrap-around portion and a shoulder portion configured to fit about the shoulders of a wearer. The wrap-around portion is movable between a retracted position wherein the wrap-around portion is generally positioned adjacent to a back of the garment and an extended position wherein the wrap-around portion is generally spaced away from the back and passable around or over the crotch of a wearer. The harness assembly includes an attachment portion configured to be attached, at a position on a front of the wearer, to the harness assembly, or to the outer shell, or to a component.

The present invention is directed to a rescue harness assembly, more particularly, to a rescue harness assembly coupled to or integrated into a protective garment.

### BACKGROUND

Firefighters and other individuals wearing protective garments are often required to enter hazardous locations when carrying out their duties. Accordingly, garments may include components which facilitate the extraction of a downed or incapacitated wearer. For example, a drag harness can be incorporated into a protective garment such that the harness can be utilized to drag the wearer to safety.

The speed with which the harness assembly can be accessed and deployed, and the speed with which the downed wearer can be moved to a safe location, are critical to successful extraction of the downed wearer. Accordingly, there is a need for a harness assembly which can be quickly and easily deployed, and which allows rapid extraction.

### SUMMARY

In one embodiment the invention is a harness assembly which can be quickly and easily deployed, and allows rapid extraction of the wearer. More particularly, in one embodiment the invention is a protective garment including an outer shell and a harness assembly configured to be generally positioned between the outer shell and a wearer of the garment when the garment is worn. The harness assembly includes a wrap-around portion and a shoulder portion configured to fit about the shoulders of a wearer. The wrap-around portion is movable between a retracted position wherein the wrap-around portion is generally positioned adjacent to a back of the garment and an extended position wherein the wrap-around portion is generally spaced away from the back and passable around or over the crotch of a wearer. The harness assembly includes an attachment portion configured to be attached, at a position on a front of the wearer, to the harness assembly, or to the outer shell, or to a component.

### BRIEF DESCRIPTION OF DRAWINGS

FIG. 1 is a front perspective view of one embodiment of the garment of the present invention, shown in an open position with the inner liner removed and with the harness in its retracted position;

FIG. 2 is a front view of the garment of FIG. 1, with the inner liner present and the harness assembly shown in hidden lines;

FIG. 3 is a rear view of the garment of FIG. 2, with certain layers cut away to show the make-up of the coat;

FIG. 4 is a rear view of the garment of FIG. 3, with the upper and lower flaps opened;

FIG. 5 is a front view of the garment of FIG. 2 being worn by a wearer;

FIG. 6 is a front view of the garment and wearer of FIG. 5, with the harness assembly in its extended position;

FIG. 7 is a rear view of the garment and wearer of FIG. 6;

FIG. 8 is a perspective view of the garment and wearer of FIG. 7 with the wearer in a downed position and a rescuer moving the wearer via the harness assembly;

FIG. 9 is a side detailed perspective view of the garment and wearer of FIG. 8, with the harness assembly passed under an anchor strap;

FIGS. 10-12 illustrate a series of steps by which the harness assembly can be coupled to the anchor strap;

FIG. 13 is a front perspective view of the garment and wearer of FIG. 6, along with a SCBA system, after the harness assembly has been attached thereto;

FIG. 14 is a front perspective view of the garment and wearer of FIG. 13, with a rescuer moving the wearer;

FIG. 15 is a front perspective view of the coat of FIG. 1, utilizing an alternate embodiment of the harness assembly; and

FIG. 16 is a front perspective view of the coat and harness assembly of FIG. 15, with the harness assembly in its extended position.

### DETAILED DESCRIPTION

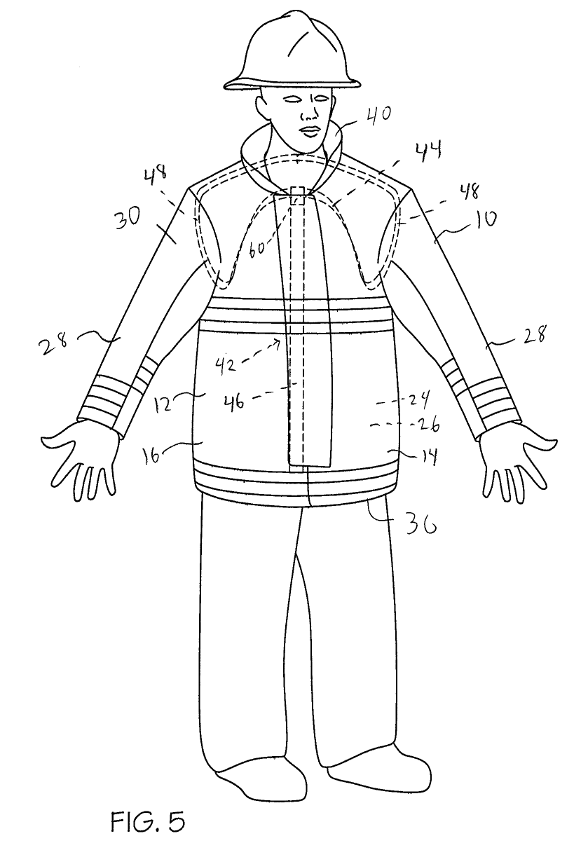

The attached figures illustrate a protective or hazardous duty garment in the form of a firefighter's coat, generally designated 10. The coat 10 may include a body portion 12 having a left front panel or portion 14, a right front panel or portion 16, and a back panel or portion 18. The panels/portions 14, 16, 18 may be made of separate pieces of material that are joined together, or can be made of a single piece of material, or various pieces of material joined in varying manners, etc. The left front panel 14 and right front panel 16 may each have an inner edge 20 that are releasably attachable together by a fastener (not shown), such as a zipper, snaps, clasps, clips, hook-and-loop fastening material (i.e., VELCRO® fastening material), combinations of these components or the like. The body portion 12 defines a torso portion/torso cavity 24 that is shaped to receive a wearer's torso 26 therein (see FIGS. 5-14). The coat 10 may include a pair of sleeves 28 coupled to and extending generally outwardly from the body portion 12 that are shaped to receive a wearer's arms therein, and may further include an upwardly extending collar 40.

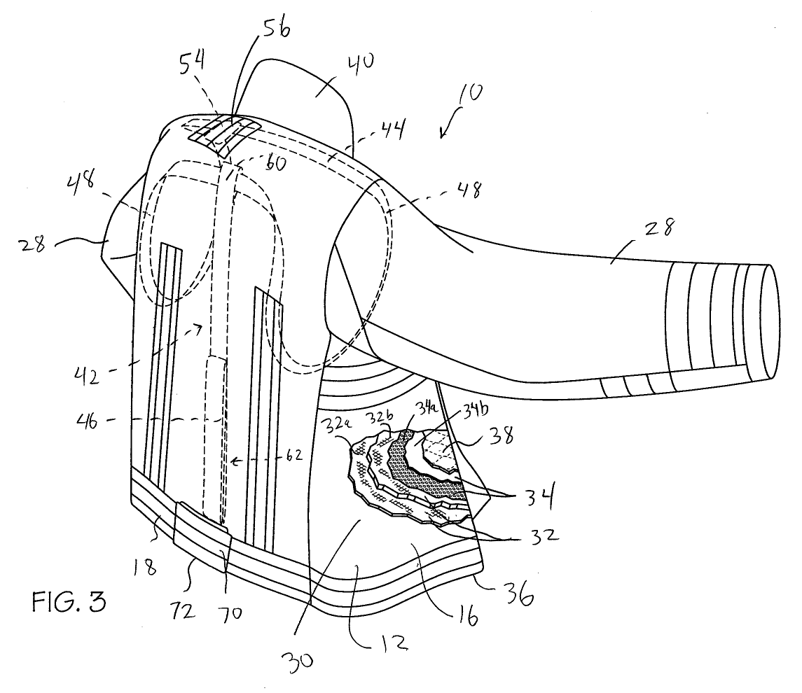

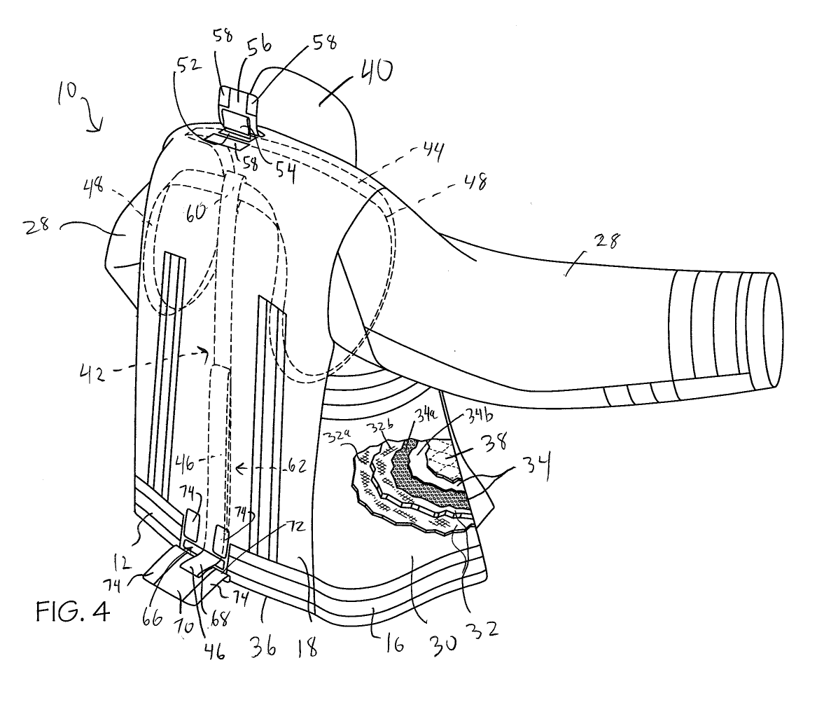

As shown in FIGS. 3 and 4, the coat 10 may include various layers through its thickness to provide various heat, moisture and abrasion resistant qualities to the coat 10 so that the coat 10 can be used as a protective, hazardous duty, and/or firefighter garment. For example, the coat 10 may include an outer shell 30, a moisture barrier/vapor barrier 32 located inside of and adjacent to the outer shell 30, and a thermal liner or barrier 34 located inside of and adjacent to the moisture barrier 32. In the illustrated embodiment the layers 30, 32, 34 are arranged such that the moisture barrier 32 is positioned between the thermal barrier 34 and outer shell 30. If desired, an inner liner or inner face cloth 38 may be located inside of and adjacent to the barrier 34, although the inner face cloth 38 may be omitted if desired.

The outer shell 30 may be made of or include a variety of materials, including a flame, heat and abrasion resistant material such as a compact weave of aramid fibers and/or polybenzamidazole fibers. Commercially available aramid materials include NOMEX and KEVLAR fibers (both trademarks of E.I. DuPont de Nemours & Co., Inc. of Wilmington, Del.), and commercially available polybenzamidazole fibers include PBI fibers (a trademark of PBI Performance Fabrics of Charlotte, N.C.). Thus, the outer shell 30 may be an aramid material, a blend of aramid materials, a polybenzamidazole material, a blend of aramid and polybenzamidazole materials, or other appropriate materials. If desired, the outer shell 30 may be coated with a polymer, such as a durable, water repellent finish (i.e. a perfluorohydrocarbon finish, such as TEFLON® finish sold by E. I. Du Pont de Nemours and Company of Wilmington, Del.). The materials of the outer shell 30 may have a weight of, for example, between about five and about ten oz/yd².

The moisture barrier 32 and thermal barrier 34 may be generally coextensive with the outer shell 30, or spaced slightly inwardly from the outer edges of the outer shell 30 (i.e., spaced slightly inwardly from the outer ends of the sleeves 28, the collar 40 (or the upper edge of the collar 40) and from the lower edge 36 of the coat 10) to provide moisture and thermal protection throughout the coat 10.

The thermal barrier 34 may be made of nearly any suitable material that provides sufficient thermal insulation. In one embodiment, the thermal barrier 34 may include a relatively thick (i.e. between about 1/16″- 3/16″) batting, felt or needled non-woven bulk or batting material 34a. The bulk material 34a can also take the form of one or two (or more) layers of E-89® spunlace fabric made of a combination of NOMEX® and KEVLAR® fabric. The bulk material 34a can also, or instead, include aramid fiber batting (such as NOMEX® batting), aramid needlepunch material, an aramid non-woven material, an aramid blend needlepunch material, an aramid blend batting material, an aramid blend non-woven material, foam (either open cell or closed cell), or other suitably thermally insulating materials. The bulk material 34a may trap air and possess sufficient loft to provide thermal resistance to the coat 10.

The bulk material 34a may be quilted to a thermal barrier face cloth 34b which can be a weave of a lightweight aramid material. Thus, either the bulk material 34a alone, or the bulk material 34a in combination with the thermal barrier face cloth 34b, may be considered to constitute the thermal barrier 34. In the illustrated embodiment, the thermal barrier bulk material 34a is positioned between the outer shell 30 and the thermal barrier face cloth 34b. However, the orientation of the thermal barrier 34 may be reversed such that the thermal barrier face cloth 34b is positioned between the outer shell 30 and the bulk material 34a. If desired, the thermal barrier 34, or parts thereof, may be treated with a water-resistant or water-repellent finish.

In one embodiment, the thermal barrier 34 has a thermal protection performance (“TPP”) of at least about twenty, and in another embodiment, at least about thirty five. Moreover, in one embodiment the coat 10 as a whole has a TPP of at least about twenty, and in another embodiment has a TPP of at least about thirty five.

The moisture barrier 32 may include a semi-permeable membrane layer 32a and a substrate 32b positioned on at least one side thereof The membrane layer 32a may be generally water vapor permeable but generally impermeable to liquid moisture. The membrane layer 32a may be made of or include expanded polytetrafluoroethylene (“PTFE”) such as GORE-TEX or CROSSTECH materials (both of which are trademarks of W.L. Gore & Associates, Inc. of Newark, Del.), polyurethane-based materials, neoprene-based materials, cross-linked polymers, polyamid, GORE® CHEMPAK® materials, sold by W.L. Gore & Associates, Inc. including GORE® CHEMPAK® Ultra Barrier Fabric, GORE® CHEMPAK® Selectively Permeable Fabric, or GORE® CHEMPAK® Sorptive Fabric, or other materials.

The membrane layer 32a may have microscopic openings that permit moisture vapor (such as water vapor) to pass therethrough, but block liquids (such as liquid water) from passing therethrough. The membrane layer 32a may be made of a microporous material that is either hydrophilic, hydrophobic, or somewhere in between. The membrane layer 32a may also be monolithic and may allow moisture vapor transmission therethrough by molecular diffusion. The membrane layer 32a may also be a combination of microporous and monolithic materials (known as a bicomponent moisture barrier), in which the microporous or monolithic materials are layered or intertwined.

The membrane layer 32a may be bonded or adhered to a substrate 32b of a flame and heat resistant material on either side thereof to provide structure and protection to the membrane layer 32a. The substrate 32b may be or include aramid fibers similar to the aramid fibers of the outer shell 30, but may be thinner and lighter in weight. The substrate 32b may be woven, non-woven, spunlace or other materials. In the illustrated embodiment, the membrane layer 32a is located between the outer shell 30 and the moisture barrier face cloth 32b. However, the orientation of the moisture barrier 32 may be reversed such that the moisture barrier face cloth 32b is located between the outer shell 30 and the membrane layer 32a.

In FIGS. 3 and 4 the moisture barrier 32 is shown as being positioned between the outer shell 30 and the thermal barrier 34. However, if desired, and for use in certain applications, the positions of the moisture barrier 32 and thermal barrier 34 may be reversed such that the thermal barrier 34 is positioned between the outer shell 30 and the moisture barrier 32.

The inner face cloth 38 may be the innermost layer of the coat 10, located inside the moisture barrier 32 and thermal barrier 34. The inner face cloth 38 can provide a comfortable surface for the wearer and protect the thermal barrier 34 and/or moisture barrier 32 from abrasion and wear. The inner face cloth 38 may be quilted to the adjacent layer (i.e. the thermal barrier 34 in the embodiment of FIGS. 3 and 4).

Each layer of the coat 10, and the coat 10 as a whole, may meet the National Fire Protection Association (“NFPA”) 1971 standards for protective firefighting garments (“Protective Clothing for Structural Firefighting”), which are entirely incorporated by reference herein. The NFPA standards specify various minimum requirements for heat and flame resistance and for tear strength. For example, in order to meet the NFPA standards, each of the outer shell 30, moisture barrier 32, thermal barrier 34 and inner face cloth 38 individually, and the coat 10 as a whole, must be able to resist igniting, burning, melting, dripping, separation and/or shrinking by more than 10% in any direction at a temperature of 500° F. for at least five minutes. Furthermore, in order to meet the NFPA standards, the combined layers of the coat 10 must provide a thermal protective performance rating of at least thirty five.

However, the coat 10 may include various arrangements of liners/materials, as desired, in which the various layers described herein are included, omitted, and/or rearranged. For example, the coat 10 may lack any thermal barrier 34, or lack any moisture/vapor barrier 32 or include only an outer shell 30 and lack other layers, etc., or may take on various other configurations as desired, and need not necessarily be NFPA compliant.

As shown in the various drawings, the coat/garment 10 may include, or be coupled to, a harness assembly 42. The harness assembly 42 is configured to be generally positioned between the outer shell 30 and a wearer of the coat 10. In particular, in one embodiment the thermal barrier 34, moisture barrier 32 and face cloth 38 are coupled together to form an inner liner component, and the harness assembly 42 is positioned between the outer shell 30 and the inner liner component (i.e., between the outer shell 30 and moisture barrier 32 in the illustrated embodiment). However, the harness assembly 42 can be positioned at various locations throughout the thickness of the coat 10, including being the inner-most component of the coat 10.

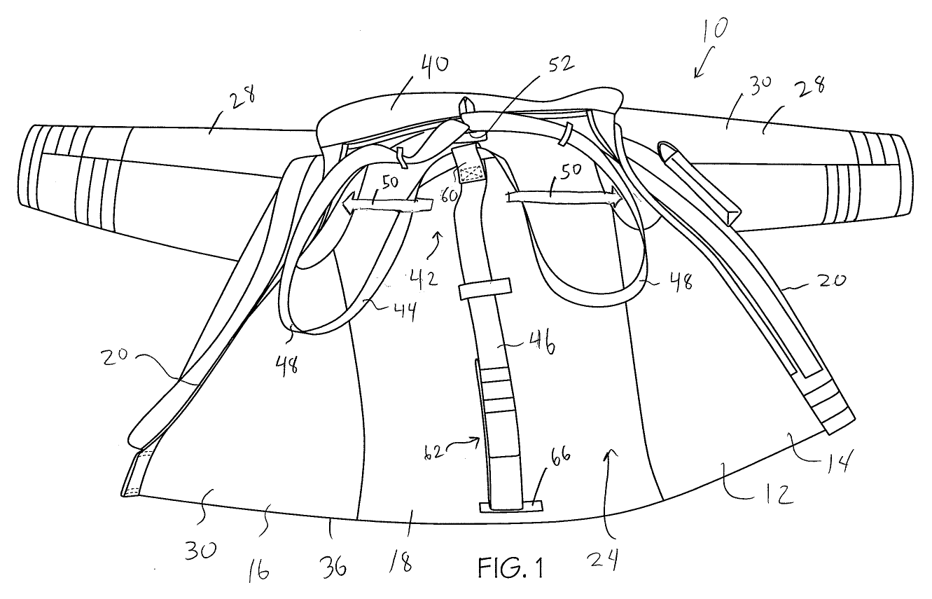

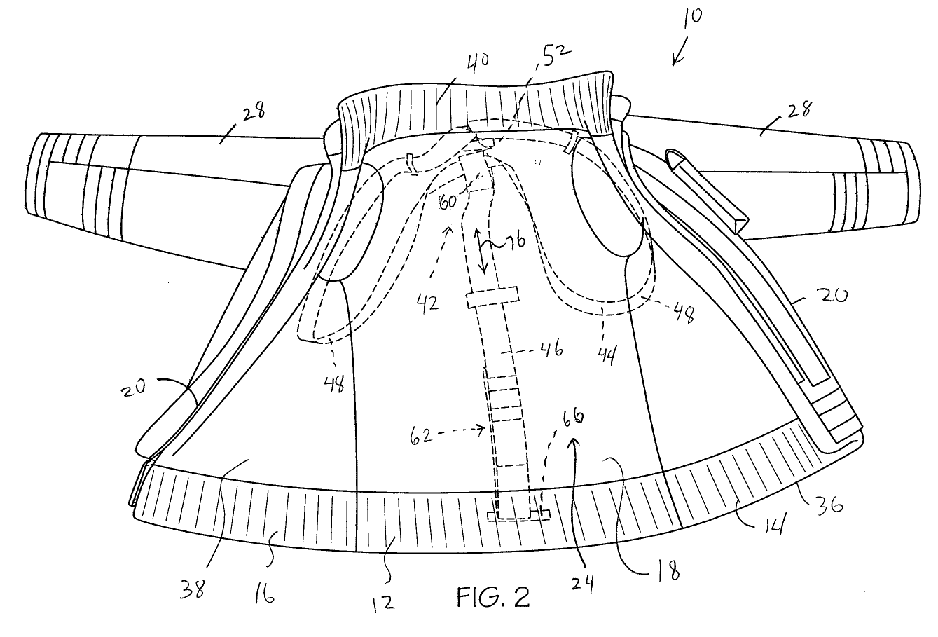

FIG. 1 illustrates the coat 10 with the inner layers removed to reveal the harness assembly 42. FIG. 2 illustrates the coat 10 with the inner layers present such that the harness assembly 42 is generally shielded from view. The harness assembly 42 may be removably coupled to the coat 10 such that the harness assembly 42 can be removed for cleaning, repair or replacement, or alternately could be permanently coupled to the coat 10, such as by stitching or the like.

The harness assembly 42 may include an upper, or shoulder portion 44, and a lower, or wrap-around portion 46. The shoulder portion 44 may take the form of a single, continuous, unitary one-piece strap configured to pass about the shoulders of a wearer and receive the wearer's shoulders therein. More particularly, in the illustrated embodiment, the shoulder portion 44 is configured as a loop having a pair of opposed ends 48. Each end 48 defines a shoulder portion which may be configured as a partial loop to receive an arm/shoulder of a wearer therethrough. When donning the coat 10, the wearer may pass his or her arms over the inner portions of the shoulder portion 44 and under the outer portion of the shoulder portion 44 as shown by the arrows 50 of FIG. 1.

As best shown in FIG. 4, an upper portion of the shoulder portion 44 may be joined together and protrude through an upper opening 52 formed in the upper central back of the coat 10 to define a gripping portion 54. Thus, in one manner of use the gripping portion 54 can be gripped and pulled upwardly by a rescuer, thereby tightening the shoulder portions 48 around the shoulders of a wearer and enabling the rescuer to drag the wearer to a desired location.

As shown in FIGS. 3 and 4, the coat 10 may include an upper flap 56 pivotally coupled to the back panel 18 along a pivot line, and releasably coupled to the back panel 18 along its free edge (i.e., by cooperating patches 58 of hook-and-loop fastening material) to selectively cover the upper opening 52 and gripping portion 54. When it is desired to access the gripping portion 54 of the shoulder portion 44, the upper flap 50 is pivoted about its pivot line, thereby exposing the gripping portion 54, as shown in FIG. 4.

The illustrated harness 42 assembly further includes the wrap-around portion 46 which in the illustrated embodiment takes the form of a single, continuous, unitary one-piece strap of material. The upper end of the wrap-around portion 46 is coupled to or formed in a loop 60 which slidably receives part of the shoulder portion 44 therethrough to slidably couple the wrap-around portion 46 to the shoulder portion 44. Although at least part of the wrap-around portion 46 is configured to be wrapped around or over the crotch of the wearer and be positioned on the front of the wearer/coat 10, as will be described in greater detail below, it should be understood that the entire wrap-around portion 46 is not necessarily configured to be wrapped around or over the wearer. Passing the wrap-around portion 46 “around” the crotch may mean that the wrap-around portion 46 changes direction as it extends over the crotch, and passing the wrap-around portion 46 “over” the crotch may mean that at least part of the wrap-around portion 46 is positioned on top of the crotch of the wearer/trousers.

FIGS. 1-5 illustrate the harness assembly 42/wrap-around portion 46 in its retracted position in which the harness assembly 42/wrap-around portion 46 is generally positioned inside the outer shell 30 (i.e., generally positioned between the outer shell 30 and the wearer of the coat 10; and/or positioned adjacent to or contained within the perimeter/projection of the back panel 18 of the coat 10). If desired, the wrap-around portion 46 may be releasably coupled to the back panel 18 of the coat 10 when in the retracted position, such as by cooperating patches of hook-and-loop fastening material (not shown). The lower end of the wrap-around portion 46 may be folded one or multiple times (visible as folds 62 in FIGS. 1 and 4) to allow the harness assembly 42/wrap-around portion 46 to be maintained in its extracted position and be generally fully positioned within the perimeter of the coat 10/back panel 18.

As shown in FIG. 4, a portion of the harness assembly 42/wrap-around portion 46 may protrude through a lower opening 66 formed in the bottom center of the back panel 18 to define a gripping portion 68. A lower flap 70 may be pivotally coupled to the back panel 18 along pivot line 72, and be releasably coupled to the back panel 18 by cooperating patches 74 of hook-and-loop fastening material to selectively cover the lower opening 66 and the gripping portion 68 of the wrap-around portion 46 (FIG. 3). The lower flap 70 may have reflective trim or other features positioned thereon allow the lower flap 70 to be easily located, and/or to blend in with adjacent portions of the coat 10. When it is desired to access the wrap-around portion 46, the lower flap 70 is pivoted about pivot line 72, thereby exposing the wrap-around portion 46, as shown in FIG. 4.

When a wearer of the coat 10 is downed, incapacitated, or otherwise needs assistance, the harness assembly 42 can be utilized in the manner described below. Initially, the lower flap 70 is pivoted to expose the wrap-around portion 46 as shown in FIG. 4, or the wrap-around portion 46 is otherwise accessed. The rescuer then grasps the wrap-around portion 46 and pulls the wrap-around portion 46 downwardly (i.e., away from the torso 26 and toward the feet of the wearer) until a length, or the majority, of the wrap-around portion 46 is extended through the lower opening 66.

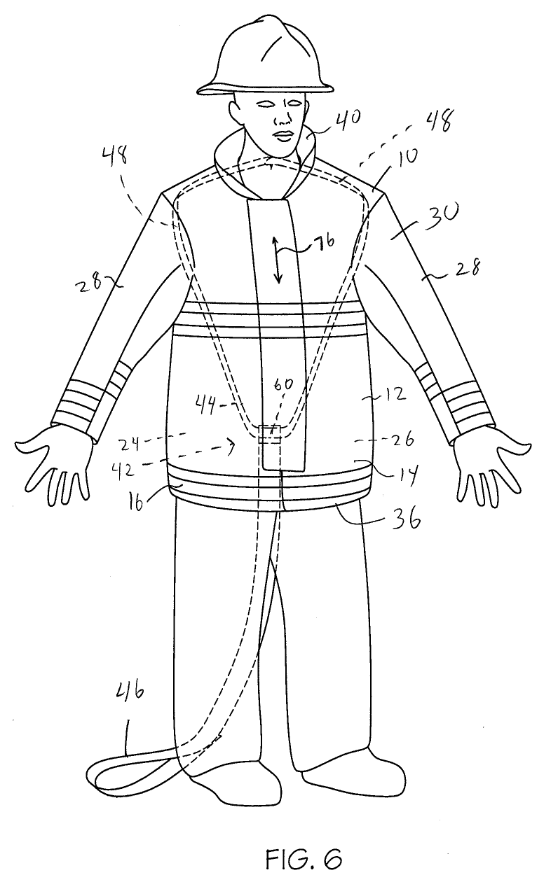

At this time the harness assembly 42/wrap-around portion 46 is in its extended position, as shown in FIG. 6. Thus, the wrap-around portion 46 is substantially entirely contained within the outer shell 30 when the wrap-around portion 46 is in the retracted position, and is substantially entirely positioned outside the outer shell 30 and substantially not contained within the outer shell 30 (its perimeter or a projection of its perimeter), and not positioned adjacent to the outer shell 30/back panel 18, when in the extended position. The wrap-around portion 46 may take the form of a single strap which extends generally downwardly and away from the back of the outer shell 30 when in the extended position.

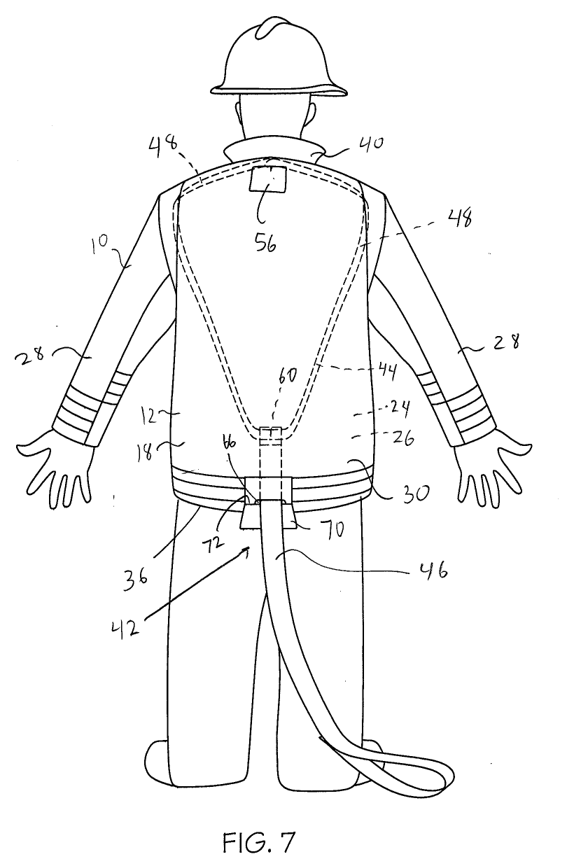

When the harness assembly 42 is moved to its extended position, at least the lower portion of the shoulder portion 44 is pulled downwardly to accommodate the movement/extension of the harness assembly 42/wrap-around portion 46 (see FIG. 6). However, the shoulder portion 44 remains passed around the shoulder of the wearer (i.e., behind the neck and over the arms of the wearer), as shown in FIGS. 6 and 7. When in the extended (or retracted) position, the wrap-around portion 46 may be substantially aligned with the spine/sagittal plane of the wearer, as well as the major axis 76 of the coat 10 (i.e., the vertical axis extending from the center of the collar 40 to the center of the lower edge 36 of the coat 10).

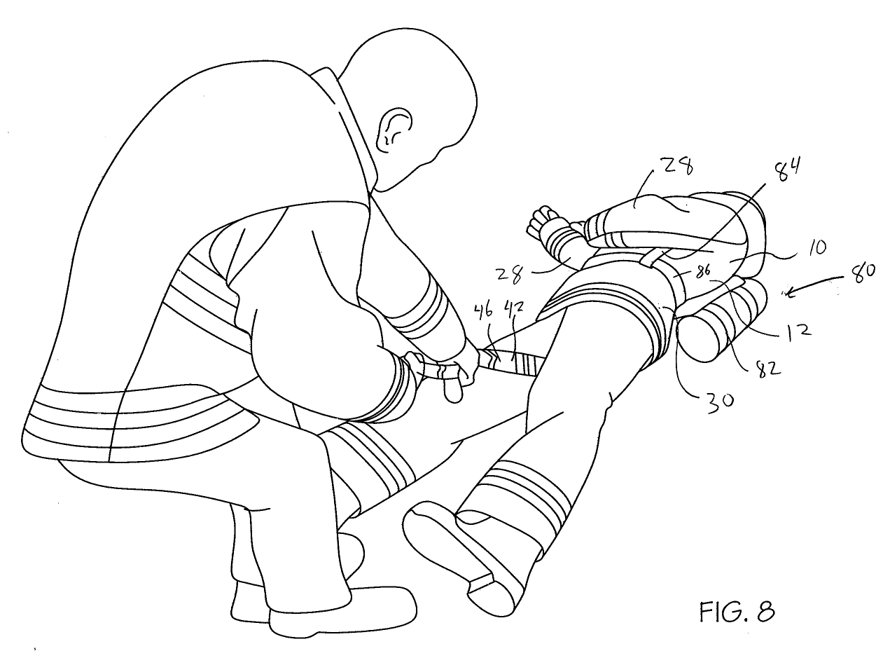

FIGS. 6 and 7 illustrate the wearer in a standing position in order to illustrate certain aspects of the invention. However, it should be understood that the wearer may be expected to be laying down in many cases when the harness assembly 42 is deployed, as shown in FIG. 8. If the wearer is in a prone position (face down), the wearer may be rolled over to the supine position (face up) for the following steps. Once the harness assembly 42 is moved into its extended position, as shown in FIG. 8, a rescuer may drag the wearer to a safer location by pulling on the harness assembly 42 in a direction away from the torso 26, toward the feet of the wearer. Although the wearer can be dragged to safety in this manner, it is expected that the dragging of the wearer in the manner shown in FIG. 8 would typically be utilized only to drag the wearer short distances to a somewhat safer location, and/or to position the wearer more conveniently for subsequent manipulation of the harness assembly 42 as described below.

As shown in FIGS. 8, 13 and 14, a wearer may often be wearing a SCBA (“self contained breathing apparatus”) system 80, including a SCBA tank 82, a pair of shoulder straps 84 extending about the shoulders of the wearer, a hip strap or waist strap 86 (also termed an anchor strap herein), extending transversely across and/or about the torso 26 of the wearer, and a chest strap 88 connecting the shoulder straps. The SCBA system 80 is typically worn over the outer shell 30 of the coat 10. A wearer/coat 10 may also have various other anchor straps, clips, hooks, clasps or components on his front surface thereof.

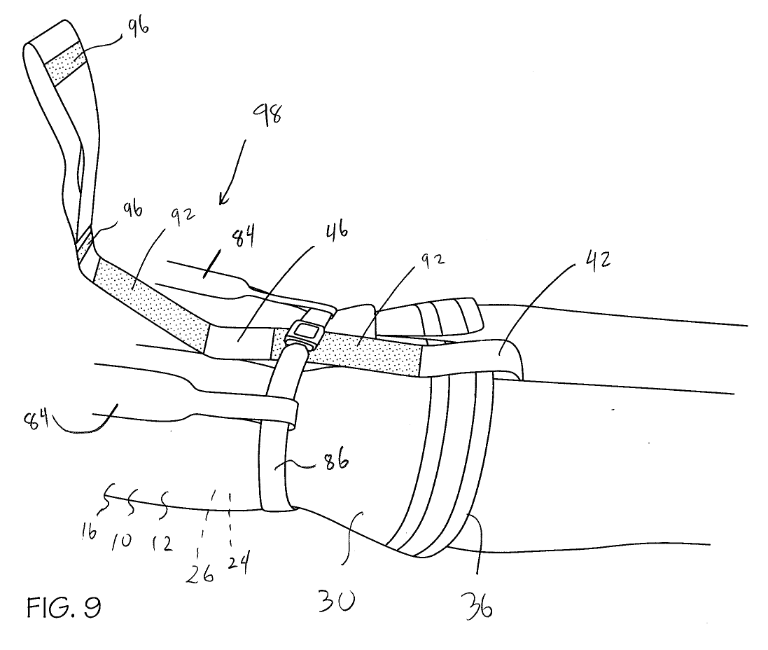

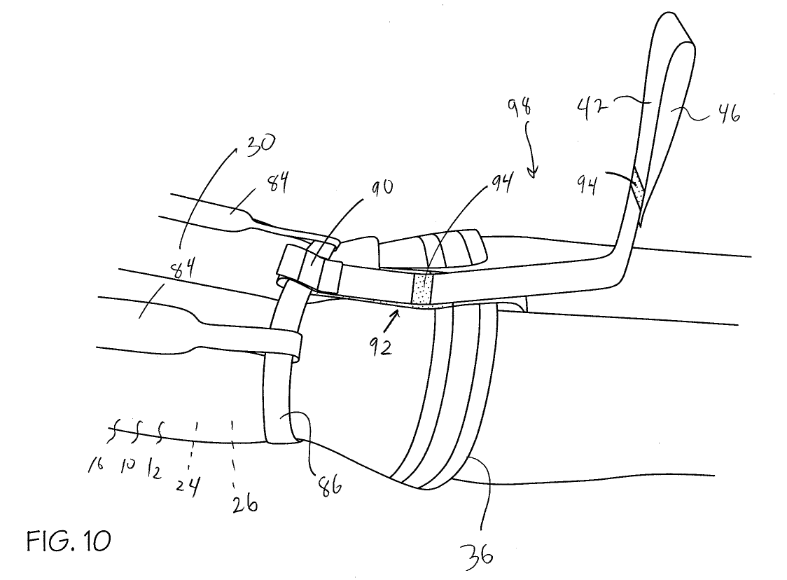

After the wrap-around portion 46 has been moved to the extended position, the wrap-around portion 46 is passed around or about the crotch of the wearer such that the leading edge of the wrap-around portion 46 is positioned in the front side of the coat 10/wearer. The wrap-around portion 46 is then passed under the hip strap 86 of the SCBA system 80 as shown in FIG. 9. As shown in FIG. 10, the wrap-around portion 46 may include a indicator 90 (i.e., a strip of colored or reflective or textured material, or text, a symbol, or the like) that is visible to provide feedback to the rescuer when the wrap-around portion 46 has been sufficiently pulled through the hip strap 86 of the SCBA system 80.

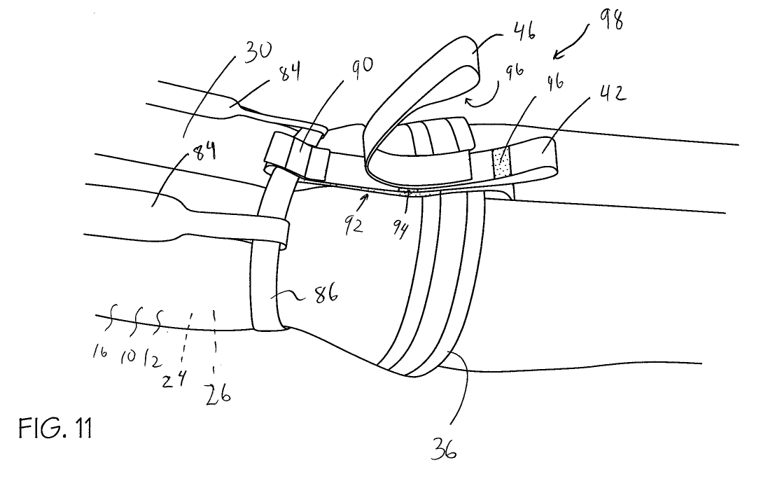

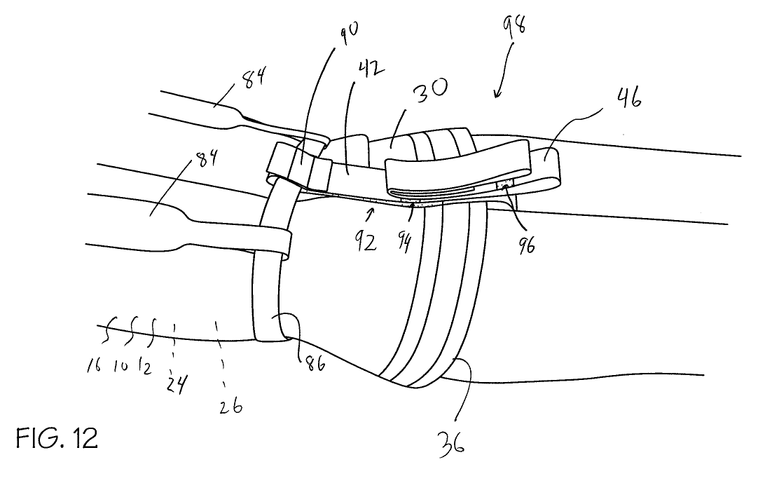

The wrap-around portion 46 is then folded about the hip strap 80 until two first portions of hook-and-loop fastening material 92 (FIG. 9) engage each other to secure the wrap-around portion 46 to itself and/or the hip strap 86 and/or the front portion of the coat 10. Next, as shown in FIGS. 10 and 11, the wrap-around portion 46 is folded and again attached to itself by second portions 94 of hook-and-loop fastening material. Finally, as shown in FIGS. 11 and 12, the wrap-around portion 46 is folded about itself, and attached to itself a third time by the third portions 96 of hook-and-loop fastening material. These folding steps allow the extra length of the wrap-around portion 46 to be secured out of the way in an intuitive and easily implemented manner, and provide a strong and secure connection, as the extra length helps to provide ease of use. However, if desired, these folded steps may be omitted, or the wrap-around portion 46 may be shortened in length such that the folding steps are not necessary.

The various patches of hook-and-loop fastening material 92, 94, 96 at or adjacent to the distal end of the wrap-around portion 46 form, or are part of, an attachment portion 98 which enables the wrap-around portion 46 to be coupled to itself and/or the hip strap 86 and/or the front portion of the coat 10/outer shell 30. However, a wide variety of fastening devices besides hook-and-loop fastening material may be used as the attachment portion 98, such as hooks, latches, fasteners, buckles, straps, buttons, zippers, ties, snaps, clasps, frictional engagements, magnetic couplings, releasable adhesives, etc. Moreover, it should be understood that rather than being configured to directly attach the wrap-around portion 46 to itself, the attachment portion 98 may be configured to attach the wrap-around portion 46 to the front of the coat 10 or to the SCBA system 80, or to other components, straps or the like on the front of the wearer/coat 10.

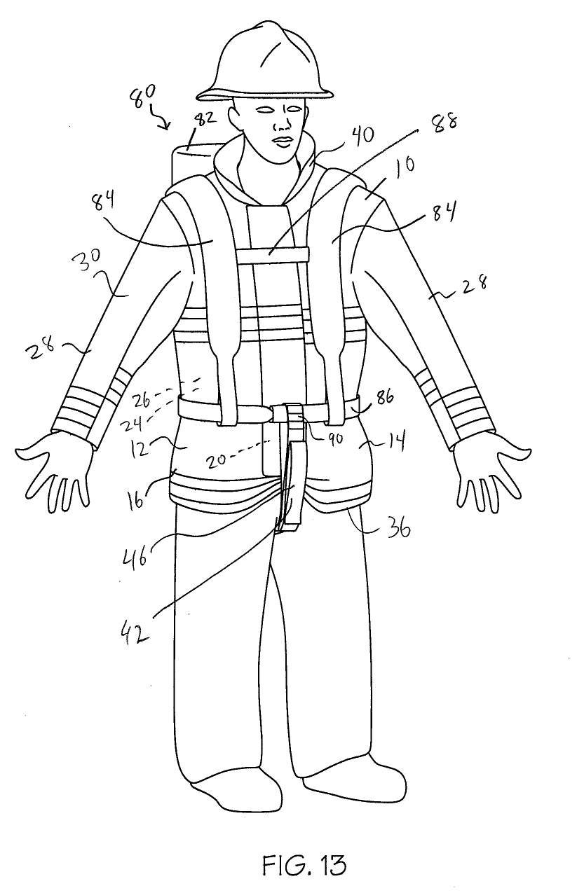

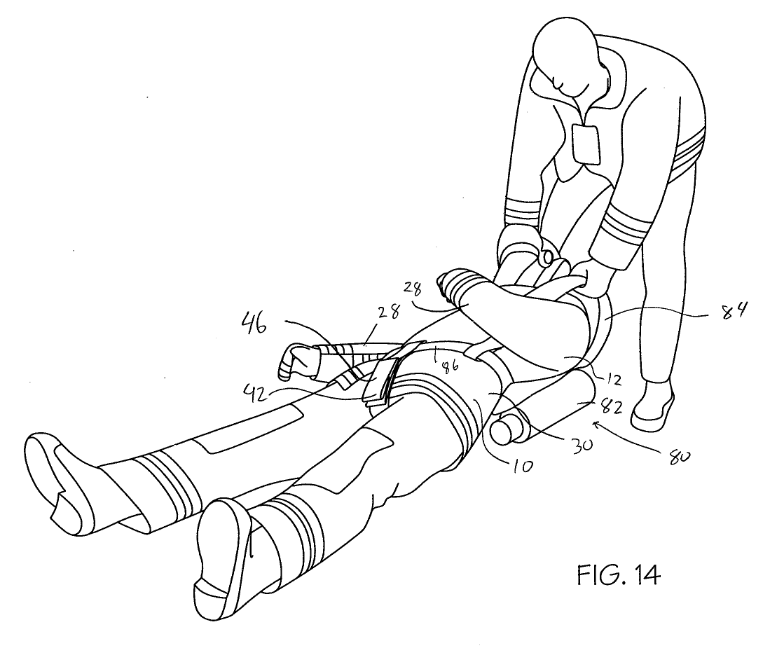

FIG. 13 illustrates the harness assembly 42 once it has been secured to the SCBA system 80 in the proper manner, and the wearer is thereby “packaged.” At this time, the SCBA system 80 is securely coupled to the wearer such that any pulling forces applied to the shoulder straps 84 or other portions of the SCBA system 80 are relatively rigidly transmitted to the body of the wearer. In this manner, as shown in FIG. 14, a rescuer can grasp one or more shoulder straps 84 of the SCBA system 80, and pull/drag the wearer to safety by the shoulder straps 84 by pulling in a direction toward the top of the wearer. The harness assembly 42, particularly the wrap-around portion 46 passed around the crotch of the wearer, ensures that such pulling forces are properly transmitted to the wearer's body, the hip strap 86 does not come undone, and that the SCBA system 80 and/or coat 10 are not pulled off of the wearer.

In this manner, the harness assembly 42 can be quickly and easily deployed, and results in a drag system which provides at least two spaced natural gripping points (i.e., the shoulder straps 84 of the SCBA system 80) which can be securely grasped to quickly and effectively pull the wearer to safety, and does not require any straps or clasps of the SCBA system 80 to be undone (which otherwise might be necessary in order to drag the wearer by the SCBA system 80). Although the wearer can be dragged to safety by the portions of the harness assembly 42 extending through the upper opening 52 (i.e., without utilizing the wrap-around portion 46), the use of the wrap-around portion 46, particularly after wrapping around the crotch of the wearer, provides a more robust, secure and easily manipulable harness assembly 42. When the wrap-around portion 46 is in its secured position (i.e., secured to the hip strap 86, SCBA system 80 and/or front portion of the coat 10), the wrap-around portion 46 remains aligned with the spine/sagittal plane/central axis 76 of the coat 10, thereby providing a central harness portion which is securely retained in position by the legs of the wearer.

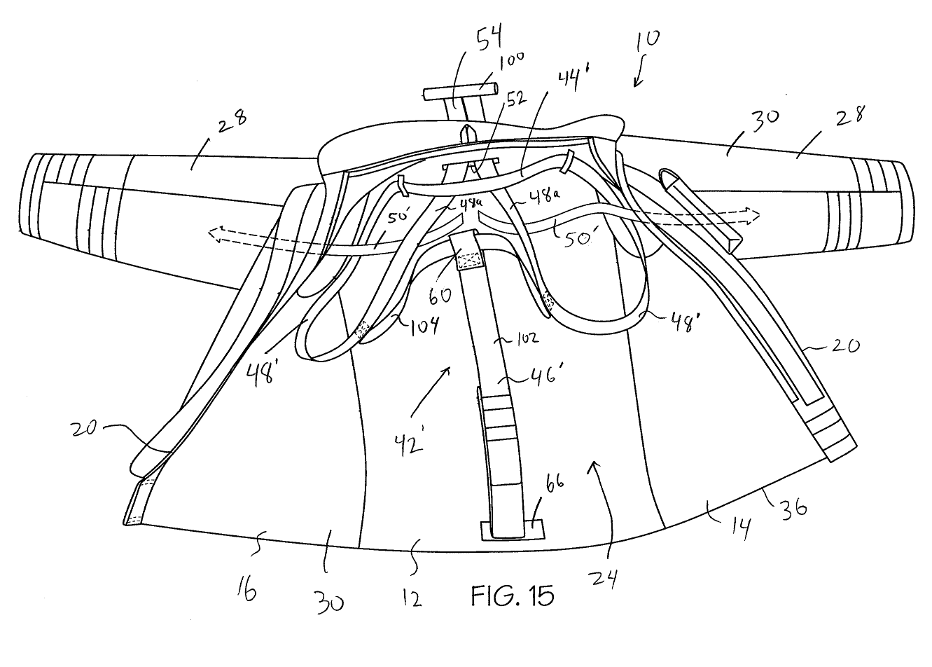

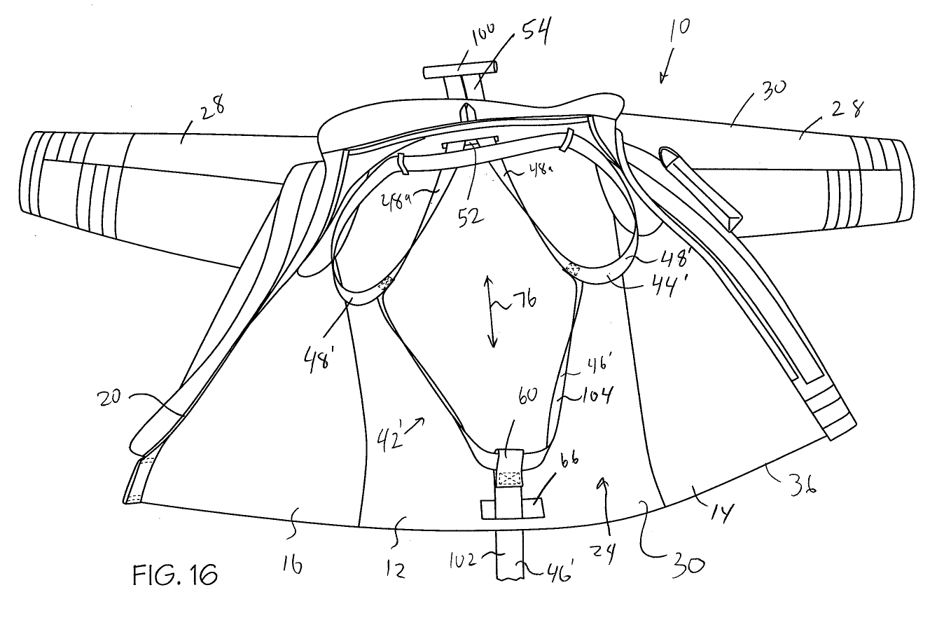

In the embodiment illustrated in FIGS. 1-14, the upper/shoulder portion 44 is formed as a open, generally non-overlapping loop, and the wrap-around portion 46 is attached to the shoulder portion 44 at a single location (at loop 66). However, the shoulder portion 44 and wrap-around portion 46 can have various other arrangements and configurations. For example, in the embodiment shown in FIGS. 15 and 16, the shoulder portion 44′ includes a pair of opposed end loops 48′, each having a free end 48a which extends upwardly behind the neck of the wearer and out of the upper opening 52 of the coat 10. A handle 100 connects the two free ends 48a of the loops 48. The harness system 42′ shown in FIGS. 15-16 is similar to that shown in U.S. Pat. No. 6,205,584, the entire contents of which are hereby incorporated by reference. The wearer dons the garment 10/harness assembly by sliding his or her arms under the inner portion of the shoulder portion 44′ and over the outer portion of the shoulder portion 44′, as shown by the arrows 50′ in FIG. 15.

In this embodiment, the wrap-around portion 46′ includes a generally vertically oriented central strap 102 and a generally laterally extending connecting portion 104. More particularly, the central strap 102 terminates in a loop 60 at its upper/distal end that slidably receives the connecting portion 104 therethrough. The connecting portion 104 is connected at each end to an associated loop 48′ of the shoulder portion 44′. The connecting portion 104 can be connected to the shoulder portion 44′ by any of a variety of methods, such as stitching, rivets, or other permanent or releasably attachments. Thus in this configuration the wrap-around portion 46′ is coupled to the shoulder portion 44′ at two positions, and the wrap-around portion 46′ has a generally “Y-shaped” configuration when in its extended position, as shown in FIG. 16. This configuration provides an even pulling force upon the shoulder loops 48′ when the wrap-around portion 46′ is moved to its extended position or when pulling forces are applied during rescue operations. Of course, various other shapes and configurations may be utilized for the shoulder portion 44, 44′, with the shape and configuration of the wrap-around portion 46, 46′ being correspondingly adjusted as desired.

Alternately, rather than having the central strap 102 slidingly receive the connecting portion 104, the central strap 102 may be fixedly and non-slidingly coupled to the connecting portion 104. Further alternately, the distal end of the central strap 102 may simply separate, or diverge, into two separate ends, wherein each end is coupled to one of the shoulder loops 48′ in the manner shown in FIGS. 15 and 16.

Many existing garments/coats may be able to be easily retrofitted to utilize the harness assembly 42 disclosed herein. In particular, some garments may already include the shoulder portions 44, 44′ disclosed herein (or can be modified to include such shoulder portions 44, 44′). In this case, the garments can be retrofitted by simply providing the wrap-around portion 46, 46′ and attaching the wrap-around portion 46, 46′ to the shoulder portion 44, 44′. If desired, the lower opening 66/lower flap 70 may also be provided during retrofitting. The garment can then be utilized in the manner described herein, providing the benefits noted above.

Although the invention is shown and described with respect to certain embodiments, it should be clear that modifications will occur to those skilled in the art upon reading and understanding the specification, and the present invention includes all such modifications. To the extent that the term “or” is employed in the claims (e.g., A or B), such usage is intended to mean “A or B or both”. When it is intended to indicate “only A or B but not both”, then the term “A or B but not both” will be utilized. Thus, use of the term “or” in the claims is the inclusive, and not the exclusive, use, unless specifically indicated otherwise.

What is claimed is:

1. A protective garment comprising:
an outer shell; and
a harness assembly configured to be generally positioned between said outer shell and a wearer of said garment when said garment is worn, said harness assembly including a wrap-around portion and a shoulder portion configured to fit about the shoulders of a wearer, said wrap-around portion being movable between a retracted position wherein said wrap-around portion is generally positioned adjacent to a back of said garment and an extended position wherein said wrap-around portion is generally spaced away from said back and passable around or over the crotch of a wearer, said harness assembly including an attachment portion configured to be attached, at a position on a front of said wearer, to said harness assembly, or to said outer shell, or to a component.

2. The garment of claim 1 wherein said attachment portion is positioned at or adjacent to a portion said wrap-around portion configured to be passed around or over the crotch of the wearer.

3. The garment of claim 1 wherein said attachment portion includes a patch of hook-and-loop fastener material.

4. The garment of claim 1 wherein said garment includes an inner liner, and wherein said harness assembly is generally positioned between said outer shell and said inner liner.

5. The garment of claim 1 wherein said outer shell includes an opening formed through a rear portion thereof, and wherein said wrap-around portion is configured to pass through said opening when said wrap-around portion is moved between said retracted position and said extended position.

6. The garment of claim 5 wherein part of said wrap-around portion protrudes through said opening when said wrap-around portion is in said retracted position.

7. The garment of claim 1 wherein said wrap-around portion is substantially entirely contained within said outer shell when said wrap-around portion is in said retracted position.

8. The garment of claim 1 wherein said wrap-around portion is substantially entirely positioned outside of said outer shell when said wrap-around portion is in said extended position.

9. The garment of claim 1 wherein said wrap-around portion is generally aligned with a sagittal plane of the wearer when said wrap-around portion is in said extended position.

10. The garment of claim 1 wherein said wrap-around portion includes a single strap generally aligned with a sagittal plane of said wearer when said wrap-around portion is in said extended position.

11. The garment of claim 1 wherein at least part of said wrap-around portion extends generally downwardly and away from said back of said outer shell when said wrap-around portion is in said extended position.

12. The garment of claim 1 wherein said wrap-around portion is directly coupled to said shoulder portion.

13. The garment of claim 1 wherein said wrap-around portion is slidingly coupled to said shoulder portion.

14. The garment of claim 1 wherein said shoulder portion is generally configured as a loop having a pair of opposed ends, each end defining one of said shoulder portions.

15. The garment of claim 1 wherein said shoulder portion is entirely positioned within a perimeter of said outer shell and is a continuous one-piece strap of material.

16. The garment of claim 1 wherein said wrap-around portion includes a central strap which is directly coupled to said shoulder portion at a single location.

17. The garment of claim 1 wherein said wrap-around portion includes a central strap and a connecting portion coupled at or adjacent to an upper end of said central strap, said connecting portion being coupled to at least two spaced apart locations on said shoulder portion.

18. The garment of claim 1 wherein said wrap-around portion is in said extended position, extends around and over the crotch of a wearer, and is coupled, at a position on said front of said wearer, to said harness assembly, or to said outer shell, or to a component.

19. The garment of claim 1 wherein said wrap-around portion is in said extended position, extends around and over the crotch of a wearer, and is coupled to said component in the form of an anchor strap positioned on a front of said wearer.

20. The garment of claim 19 further comprising said anchor strap, wherein said anchor strap is positioned on an outer surface of said outer shell such that said outer shell is positioned between said anchor strap and said wearer.

21. The garment of claim 20 wherein said anchor strap is a transversely-extending strap coupled to or part of a SCBA system.

22. The garment of claim 1 wherein said outer shell is a coat configured to cover the torso and arms of a wearer.

23. The garment of claim 1 wherein said garment conforms with National Fire Protection Association 1971 Standards for Protective Firefighting Garments.

24. The garment of claim 1 wherein said outer shell resists igniting, burning, melting, dripping or separation when exposed to a temperature of 500° F. for at least five minutes.

25. The garment of claim 1 further comprising a thermal barrier located generally inside said outer shell such that said thermal barrier is positioned between said outer shell and a wearer when said garment is worn, wherein said thermal barrier has a thermal protection performance of at least about twenty.

26. The garment of claim 1 further comprising a moisture barrier located generally inside said outer shell such that said moisture barrier is positioned between said outer shell and a wearer when said garment is worn, said moisture barrier being generally liquid impermeable and generally moisture vapor permeable.

27. A protective garment comprising:
an outer shell; and
a harness assembly configured to be generally positioned between said outer shell and a wearer of said garment when said garment is worn, said harness assembly including a wrap-around strap and shoulder portion configured to fit about the shoulders of a wearer, said wrap-around strap being movable between a retracted position wherein said wrap-around strap is generally positioned within a back of said garment and an extended position wherein said wrap-around strap is generally spaced away from said back and passable around or over the crotch of a wearer such that said wrap-around strap is generally aligned with a central axis of said garment.

28. A protective garment assembly comprising:
an outer shell; and
a harness assembly coupled to said outer shell and including wrap-around portion extending from a position on a back of said garment, extending around or over the crotch of a wearer, and attached to an anchor strap positioned on a front of said wearer.

29. The assembly of claim 28 wherein at least part of said harness assembly is generally positioned between said outer shell and a wearer of said garment.

30. The garment of claim 28 wherein said wrap-around strap is generally aligned with a sagittal plane of the wearer.

31. The garment of claim 28 further comprising said anchor strap, and wherein said anchor strap is a transversely-extending strap coupled to or part of a SCBA system.

32. The assembly of claim 28 wherein said harness assembly includes shoulder portion positioned about the shoulders of a wearer.

33. The assembly of claim 28 wherein said wrap-around portion is movable between a retracted position wherein said wrap-around portion is generally entirely positioned adjacent to a back of said garment and an extended position wherein said wrap-around portion is generally spaced away from said back and extendable around or over the crotch of a wearer.

34. A method for manipulating a protective garment comprising:
accessing a protective garment having an outer shell and a harness assembly, said harness assembly including a wrap-around portion and shoulder portion;
donning said protective garment such that said harness assembly is generally positioned between said outer shell and a wearer of said garment, said shoulder portion is generally positioned about the shoulders of a wearer, and said wrap-around portion is in a retracted position wherein said wrap-around portion is generally entirely positioned within said outer shell;
moving said wrap-around portion to an extended position wherein at least part of said wrap-around portion is extended away from said outer shell;
passing said wrap-around portion around or over the crotch of the wearer; and
manipulating said wrap-around portion such that said wrap-around portion is secured on a front of said garment.

35. The method of claim 34 wherein an anchor strap, that is coupled to or part of a SCBA system, is positioned on said front portion of said garment, and wherein said manipulating step includes securing said wrap-around portion to said anchor strap.

36. A method for manipulating a protective garment comprising:
accessing a protective garment having an outer shell and a harness assembly configured to be generally positioned between said outer shell and a wearer of said garment when said garment is worn, said harness assembly including a shoulder portion configured to fit about the shoulders of a wearer;
incorporating a wrap-around portion into said harness assembly, said wrap-around portion being movable between a retracted position wherein said wrap-around portion is generally positioned adjacent to a back of said garment and an extended position wherein said wrap-around portion is generally spaced away from said back and passable around or over the crotch of a wearer, said harness assembly including an attachment portion configured to be attached, at a position on a front of said wearer, to said harness assembly, or to said outer shell, or to a component.
